(19) United States
(12) Patent Application Publication
(10) Pub. No.: US 2018/0347266 A1
(43) Pub. Date: Dec. 6, 2018

(54) INVISIBLE BURGLAR BARS

(71) Applicant: John Williams, Atlanta, GA (US)

(72) Inventor: John Williams, Atlanta, GA (US)

(21) Appl. No.: 15/614,832

(22) Filed: Jun. 6, 2017

(51) Int. Cl. E06B 9/01; E06B 3/68

(52) U.S. Cl. CPC E06B 9/01; E06B 2009/015; E06B 3/685

(57) ABSTRACT

A security system and method for preventing unwanted passage through windows and doors of a building includes custom sizing and welding of hardened steel structures that mount into the door jam or window frame, on the inside of the door or window with the use of threaded fasteners. The custom assembled structure consists of an outer frame and horizontal and vertical pickets that may be formed of flat stock, hollow square or rectangular steel tubing or solid square hardened steel bars. The system and method involves specifically spacing the vertical and horizontal pickets so as to lineup with an ornamental structure on the window or door (e.g., grids) without obstructing the view of the door or window so that the steel bars of the security structure is essentially invisible.

### BACKGROUND OF THE INVENTION

This non-provisional patent application is based on provisional patent application Ser. No. 29/552,749 filed on Jun. 6, 2016.

### DISCUSSION OF THE RELATED ART

A well-known system to prevent unwanted intrusion through doors and windows of a home or building is to install welded steel bars to the outside of the home or building in blocking relation to the window or door so that an intruder cannot easily break and enter through the window or door. The welded steel structure, commonly referred to as burglar bars, is anchored to the outside of the building with the use of bolts and recessed threaded anchors that are fitted within the exterior wall structure of the home or building. Because the burglar bars are mounted to the outside of the structure, they can be removed by a potential intruder with proper tools. Moreover, burglar bars are highly visible and unsightly which significantly impacts the architectural beauty of a home or building.

In view of the shortcomings of commonly known burglar bars in the related art, and particularly the ability to easily remove the burglar bars from the exterior structure of a home or building, there remains a need for an improved method and system that not only enhances the overall appearance of burglar bars, but prevents the ability for an intruder to remove the burglar bars from outside of the home or building.

### SUMMARY OF THE INVENTION

The present invention is directed to a system and method for a security system, and particularly a security bar system that prevents unwanted passage through doors and windows of a home or building structure, while maintaining the aesthetic look of the surface and glass windows and the overall architectural beauty of the home or building. The hardened steel security bars of the present invention are custom welded for each door and window and are anchored to the surface by resistant elements (e.g., hardened steel or stainless steel screws or bolts). Use of angle iron frames allows the assembled security bars to be mounted into the door jam or window frame which prevents unwanted entry without removing the entire door jam or window frame. The completed security bar assembly can consist of angle iron and flat stock, angle iron and hollow square or rectangular tubing or solid steel bars and is custom arranged to align with the existing ornamental structure on the door or window, such as grids or other curved designs, thereby making the security bars invisible without obstructing the view through the glass of the door or window and improving the overall aesthetic look of the door or window.

### BRIEF DESCRIPTION OF THE DRAWINGS

For a fuller understanding of the nature of the present invention, reference should be made to the following detailed description taken in conjunction with the accompanying drawings in which:

FIG. 1 is an isolated perspective view of a corner of one of the invisible security bar structures of the present invention in accordance with one embodiment, with an outer frame structure formed of angle iron and horizontally and vertically crossing pickets are formed of hardened steel flat stock;

FIG. 2 is an isolated perspective view of a corner portion of yet another embodiment of the invisible security bar of the present invention wherein the surrounding frame structure is formed of a hollow rectangular square tubing and the horizontal and vertical crossing pickets formed of solid square steel bars;

FIG. 3 is an isolated perspective view of a corner portion of the invisible security bar of the present invention in yet a further embodiment wherein the surrounding frame structure is formed of hollow or square rectangular tubing and the crossing horizontal and vertical pickets are formed of flat stock;

FIG. 4 is an exploded perspective view showing one embodiment of the invisible burglar bars of the present invention mounted to the inside of a window frame so that the vertical and horizontal pickets of the invisible burglar bars align with an existing grid design on the window; and

FIG. 5 is an isolated bottom perspective view showing one embodiment of the invisible burglar bars of the present invention being mounted to the inside of a window frame with vertical and horizontal flat stock pickets of the invisible burglar bars dispersed in aligning relation to the existing grid design of the window so that the horizontal and vertical flat stock hardened steel pickets of the invisible burglar bars are not visible through the window from an exterior of the building structure.

Like reference numerals refer to like parts throughout the several views of the drawings.

### DETAILED DESCRIPTION OF THE PREFERRED EMBODIMENTS

Referring to the several views of the drawings, the security system of the present invention is shown and is generally indicated as 10. According to the system and method of the present invention, a custom sized burglar bar structure 12 is formed of hardened steel components. The burglar bar structure is custom assembled to fit within a door jam or window frame of a home or building on the inside to prevent unwanted entry through the door or window.

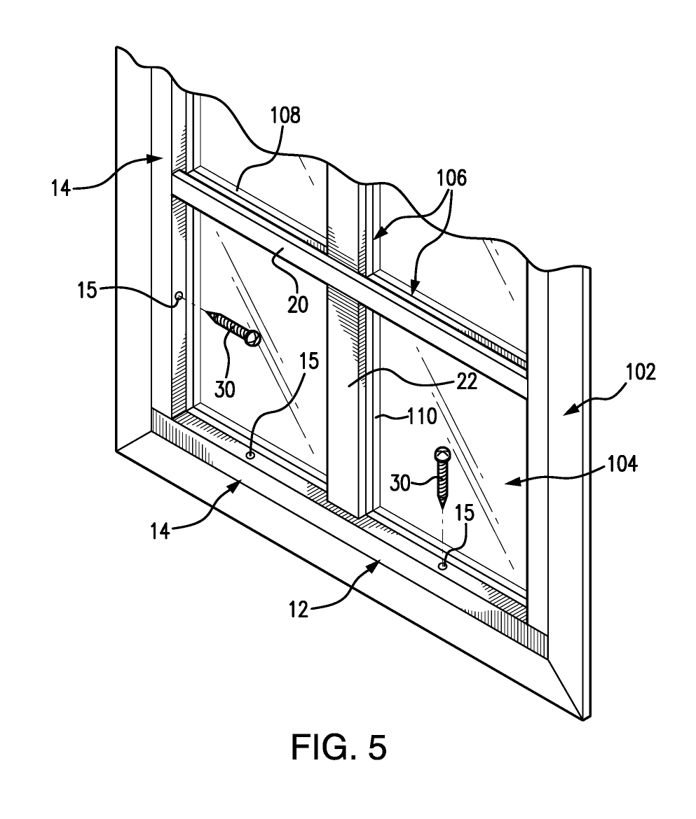

The burglar bar structure 12 includes a peripheral frame structure 14 that fits within the door jam or window frame and is secured thereto with the use of fasteners 30 (see FIG. 5) that pass through predrilled or preformed openings 15 in the peripheral frame 14. The burglar bar structure further includes interior hardened steel components 16 that are welded to the peripheral frame 14. In several embodiments of the invention, wherein the burglar bar structure is specifically designed to be installed at a window or door having a square or rectangular grid structure on the glass of the door or window, the burglar bar structure includes horizontal pickets 20 and vertical pickets 22 that are specifically sized, spaced and arranged to align with the horizontal and vertical grid members on the glass of the door or window, so that when the burglar bars are installed, they are not visible from an exterior of a home or building.

The burglar bar structure contemplates use of various hardened steel components according to several embodiments of the invention. In particular, both the outer peripheral master frame and the interior components (e.g., horizontal and vertical pickets) may be formed of any combination of angle iron components, square tubing components, rectangular tubing components, flat stock and/or solid square bars.

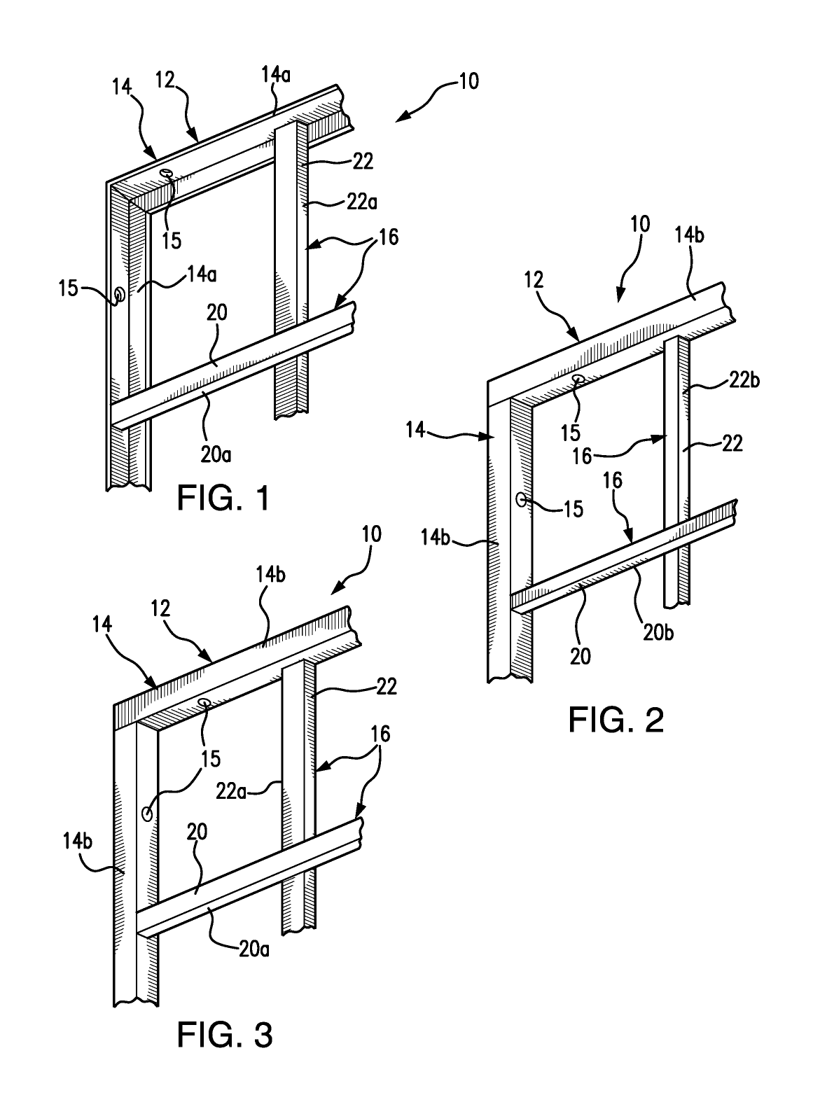

Referring to FIG. 1, one embodiment of the invention uses angle iron components 14a formed of hardened steel for the peripheral master frame 14 while the horizontal pickets 20 and vertical pickets 22 are formed of hardened steel flat stock, specifically 20a and 22a.

Referring to FIG. 2, another embodiment of the burglar bars 12 is shown, wherein the peripheral master frame 14 is formed of hardened steel square or rectangular tubing components 14b and the pickets are formed of horizontal solid square hardened steel bars 20b and vertical solid square hardened steel bars 22b.

In another embodiment, FIG. 3 shows the outer peripheral master frame 14 is formed of square or rectangular hardened steel tubing 14b and the pickets are formed of hardened steel flat stock horizontal pickets 20a and hardened steel flat stock vertical pickets 22a.

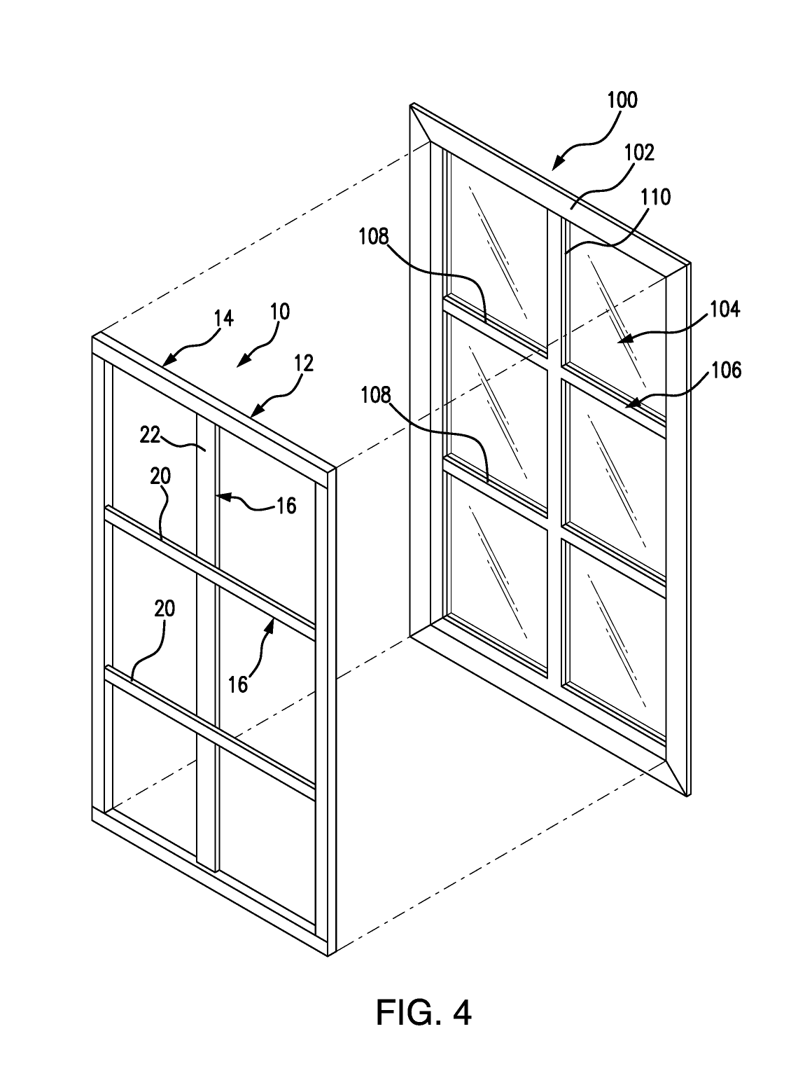

Referring to FIG. 4, an assembled invisible burglar bar structure 12 of the present invention is shown being installed to a window 100 having a surrounding window frame 102, one or more glass panes 104 and a grid structure 106 consisting of horizontal grid components 108 and at least one vertical grid component 110. The invisible burglar bar structure 12 is mounted to the window frame 102 so that the horizontal pickets 20 align with the horizontal grid components 108 on the window and the vertical picket 22 aligns with the vertical grid component 110 on the window.

Referring to FIG. 5, an isolated perspective view of the invisible burglar bar structure 12 is shown being mounted within the window frame 102 with the use of threaded fasteners 30 and wherein it is clearly shown that the horizontal picket 20 aligns with the horizontal grid component 108 on the window and the vertical picket 22 aligns with the vertical grid component 110 on the window so that the burglar bar structure 12 is not visible from an exterior of the window and is not easily seen from the interior. Moreover, when installed, as seen in FIG. 5, the invisible burglar bar structure 12 does not interfere with the preexisting window, and particularly the ability to view out through the window panes 104. Moreover, the overall aesthetic appearance of the preexisting window structure is maintained, as the invisible burglar bar assembly 12 does not alter the appearance of the window.

While the present invention has been shown and described in accordance with several preferred and practical embodiments, it is recognized that departures from the instant disclosure are fully contemplated within the spirit and scope of the present invention which is not to be limited except as defined in the following claims.

1. (canceled)

2. (canceled)

3. (canceled)

4. (canceled)

5. (canceled)

6. (canceled)

7. (canceled)

8. (canceled)

9. (canceled)

10. (canceled)

11. A method for preventing unwanted entry through window and door openings that have a glass window with a window frame and a decorative grid structure on the glass window, the method comprising the steps of:
providing a peripheral frame structure and sizing the peripheral frame structure to fit within the window frame in abutting engagement therewith;
providing horizontal pickets and vertical pickets to be attached to the peripheral frame structure;
arranging the horizontal pickets and the vertical pickets on the peripheral frame structure so that the horizontal pickets and vertical pickets align with horizontal and vertical grid members of the decorative rectangular grid structure on the glass window;
welding the horizontal pickets and the vertical pickets to the peripheral frame structure at the arranged positions that align with the horizontal and vertical grid members; and
securing the peripheral frame structure to the window frame at an interior side of the glass window with the use of threaded screw fasteners passing through the peripheral frame structure and into the window frame so that the peripheral frame structure, the horizontal pickets and the vertical pickets are not visible from an exterior side of the glass window.

12. The method as recited in claim 11 wherein the peripheral frame structure, the horizontal pickets and the vertical pickets are formed of hardened steel.

13. A method for preventing unwanted entry through window and door openings that have a glass window with a window frame and a decorative structure on the glass window, the method comprising the steps of:
providing a peripheral frame structure and sizing the peripheral frame structure to fit within the window frame in abutting engagement therewith;
providing interior rigid components to be attached to the peripheral frame structure, and wherein the interior rigid components align with the decorative structure on the glass window;
welding the interior rigid components to the peripheral frame structure so that the interior rigid components align with the decorative structure on the glass window; and
securing the peripheral frame structure to the window frame at an interior side of the glass window with the use of threaded screw fasteners passing through the peripheral frame structure and into the window frame so that the peripheral frame structure and the interior rigid components are not visible from an exterior side of the glass window.

14. The method as recited in claim 13 wherein the peripheral frame structure and interior rigid components are formed of hardened steel.
